(19) United States
(12) Patent Application Publication
(10) Pub. No.: US 2003/0139951 A1
(43) Pub. Date: Jul. 24, 2003

(54) Reservation system

(76) Inventors: Christopher H Seal, Reading (GB); David J McCartney, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/275,476

(22) PCT Filed: May 23, 2001
(86) PCT No.: PCT/GB01/02297

(30) Foreign Application Priority Data
May 23, 2000 (EP) 00304350.2

(51) Int. Cl. G06F 17/60

(52) U.S. Cl. 705/5

(57) ABSTRACT

A reservation system, particularly suited to small businesses, includes, a database accessible through the public switched telephone network (PSTN), an electronic diary at each serviced customer premises and a plurality of customer telephone channels connecting each customer premises to the PSTN.

In use, when a potential customer contacts the supplier, the electronic diary uses the second line to effect a simultaneous call to the database. The electronic diary and corresponding data in the database are kept synchronised so that the database may be used with certainty for assisting intermediaries to determine availability at each of a number of small suppliers.

Alternatively, the network may act as an intermediary, connecting calls to potential suppliers based on the information held in the database. Because the electronic diary and database are always in step small suppliers can use the system without having to pre-allocate accommodation/commodity to a particular intermediary.

The present invention relates to a reservation system and more particularly to such a system using synchronised data bases.

Many businesses use intermediaries to sell their services or inventories to third parties. In particular, it is known for hotels and hotel chains to offer room reservations through agencies or through a centralised reservation system. However, such systems usually rely upon pre-allocating a number of rooms in each hotel to each agency with which the supplier has an agreement. Such systems having a “quota” arrangement may result in lost business since, while rooms are pre-allocated to quotas are not available for localised booking. Similarly, when an agency is contacted and its quota has been “sold” booking may be lost if there are other rooms available which have not been sold.

While such systems may be acceptable for larger businesses, smaller guest houses, hotels and inns may not be able to pre-allocate rooms in such a manner so that where an arrangement may exist (for example with a tourism office) it is necessary for a call to be made every time there is a potential customer. This can result in a large number of calls being made before a room is found. Further, smaller businesses may rely on paper diary or booking systems because a computerised booking system may represent an unacceptable business expense and allowing full time “connection” to (e.g.) the internet to enable on-line booking may also be uneconomic.

It is also known that many smaller businesses prefer direct customer contact. According to the present invention there is provided a reservation system comprising an electronic diary system at each customer premises of a plurality of customers, and a central data base accessible by way of a telecommunications network, the central data base including a respective copy of at least some fields of each customer diary, each said electronic diary system being responsive to an incoming voice call to a first connection at the customer premises to establish a call through a second connection at the same premises to the central database and to synchronise with said central database at least one data field relating to booking of facilities at said customer premises, the diary system further including display means to display said synchronised information and means responsive to customer data entry to re-synchronise said at least one data field with said central database.

The central database may have an associated connection to one or more intermediaries whereby each such intermediary may check the potential availability of a required commodity before attempting direct communication with the customer premises.

In a preferred embodiment, the commodity comprises accommodation facilities.

The network through which customer connection is made may include facilities to intercept calls, determine potential customer requirements and refer calls directly to suppliers shown as having availability. Alternatively or additionally, the network may have time of day and/or day of week interception capability so that unsociable hours calls to an enquiry line can be prevented.

The data fields held in respect of each customer diary may include minimum and maximum customer numbers for each of a plurality of rooms, number of rooms available and identity of such rooms together with date related data defining availability of each identified room.

If a caller accesses the system and is automatically connected to an appropriate customer premises a referral count may be made such that billing may be based on the number of referrals made. Alternatively or additionally, referrals resulting in a change of status of one or more rooms may result in a successful referral count being incremented.

A system in accordance with the invention will now be described by way of example only with reference to the accompanying drawings of which:

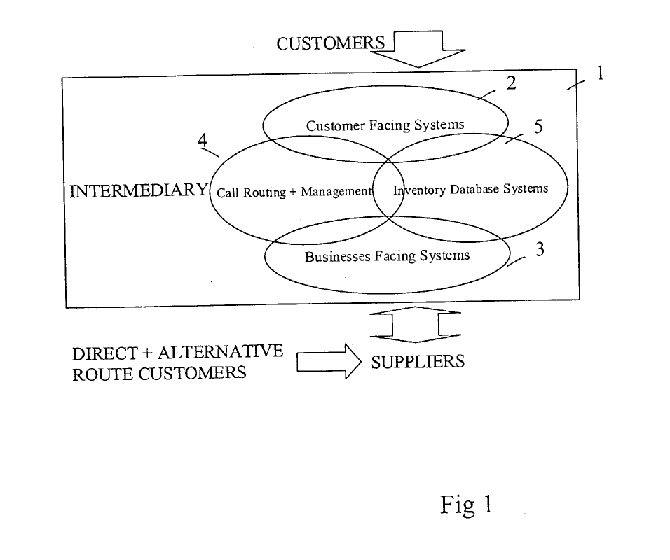

FIG. 1 is a schematic diagram showing interaction between customers, suppliers and intermediaries;

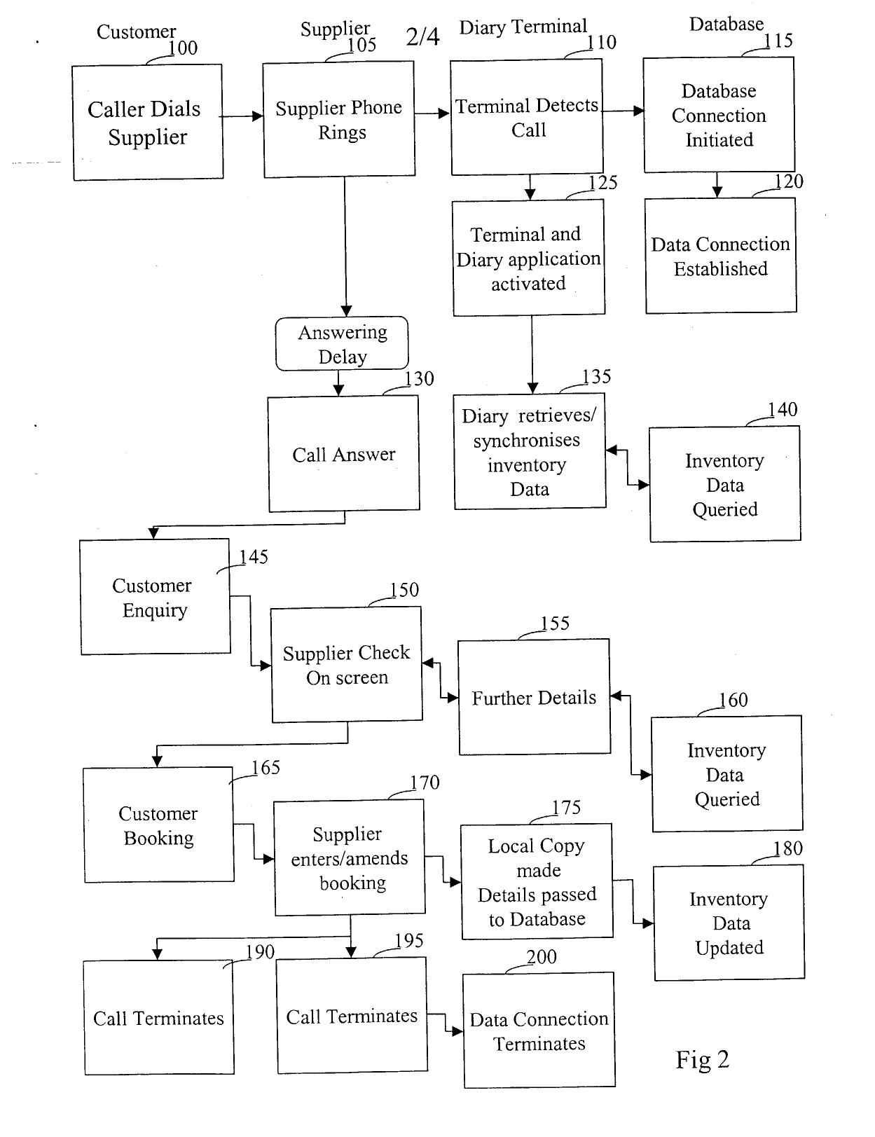

FIG. 2 is a time line diagram showing typical interaction between customer, supplier and central database; and

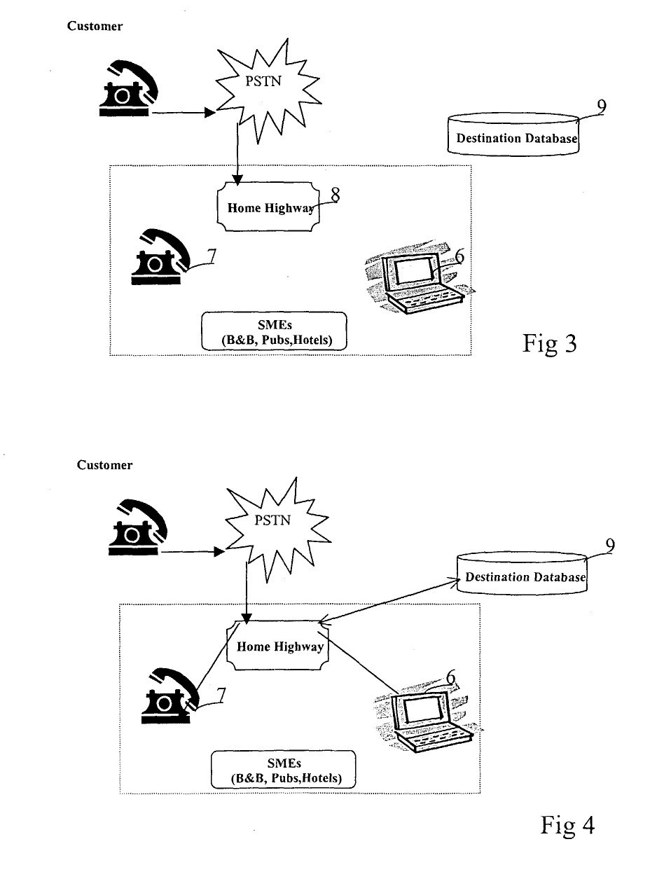

FIGS. 3 to 5 show the interaction between telephony, customer premises electronic diary and the central database.

Hereinafter there is described a number of facilities enabling supply of a reservation service to small and medium enterprises. The reservation system includes an electronic diary (palm top computer for example such as those marketed by Psion (Psion Organiser), Hewlett Packard (320LX), Palm Pilot and the like) which is capable of running programs based on Windows CE operating systems or equivalent thereof and which include modem capability. The electronic diary is programmed to react to incoming calls to the customer telephone line so that updates of availability or inventory are shared immediately with intermediaries. Effectively the invention provides a small business with a call centre type operation in which the supplier can be connected to a voice call and a remotely based database server at the same time.

In a further aspect, the database server may act as an automated call distribution service (ACD) connecting customers to potential suppliers based on information held centrally in the server. In this way a number of potential (small) suppliers who are known to have availability can be passed customers from a central contact number. Thus using data which defines geographical location, availability and other parameters the ACD can refer a caller to a likely supplier.

The ACD function also provides (e.g.) handling of out of hours calls or unanswered calls which may use an inter-active voice response function to interact with the availability/inventory system.

It is expected that the intermediary (PSTN Operator or others) would effect charging for the service on the basis of telephony charges or referral charges not a commission so that small business are not disadvantaged by high commission rates.

Thus referring now to FIG. 1, the reservation system 1 of the invention interfaces customers on one hand (by way of a customer facing system 2 having a point of presence (e.g. on the PSTN)) to suppliers on the other hand (by way of a business facing system 3 also having a respective point of presence.) The whole of the system 1 may be implemented on an appropriate programmable server. Interfacing between the facing systems 2,3 is by functional call routing and management 4 programs having access to an Inventory database system 5.

The inventory database system, as in many computerised reservation systems, needs to be “authoritative”. Traditionally authoritative computer systems ensure that data across an entire system is maintained in step so that users and agents are prevented from booking the same inventory. There will always be one authoritative record of inventory availability which for smaller suppliers such as a guest house or other “Small or Medium enterprise” (SME) supplier may be a paper stock control or diary system. Lack of synchronisation between the authoritative record and inventory intermediaries may result in double booking.

The customer facing systems 2 may be Website, call centre terminal systems or interactive voice response or prompt and collect arrangements, each of these needs to communicate with the intermediary to determine inventory availability. The electronic intermediary is used by the customers to gain visibility of supplier inventory and/or so that they may be routed through to an appropriate supplier.

Larger suppliers (who may also have customers calling directly or through other agencies) either allow the electronic intermediary to be the authoritative inventory record or allow direct access to their own databases. SMEs may not have such capability and/or may not wish to use a communications link on a twenty four hour basis.

The business facing systems 3 represent ways in which the intermediary may deal with suppliers, to update the database 5 with the parameters allocated by the supplier such as inventory availability, pricing, commission or referral fee accounting and the like.

Call routing and management 4 allows the system to “add value” by routing voice calls to a suitable supplier and to manage the network requirements of the SMEs so that they have control and visibility of inventory.

Combining the call routing and management function 4 within the intermediary function enables use of the communications capability to allow connection to a large number of dispersed suppliers. The system thus permits even individual suppliers to have a so-called “e-commerce” capability and wide area visibility. The call routing and management system thus has the ability to integrate supplier data handling with customer voice connection. Thus if an incoming call for service occurs at the same time as a current voice and data connection is in use with a particular supplier the call may be routed alternatively to another supplier or held pending clearance of the first incoming call and a further check on the inventory prior to connecting the later call.

Turning now to FIG. 2, in providing an SME with a “one man” call centre capability, the electronic diary function is programmed to recognise and incoming call to effect connection to the inventory database. Thus in the case of (e.g.) a guest house for example when a caller direct dials the supplier (100) a PSTN connection is established and the customer premises phone will be alerted (105). This triggers the electronic terminal (110) which initiates a call through a second line to the database (115) which then establishes the data connection (120). As the data connection is established, the terminal and diary function is fully activated. As may be expected this is a fairly quick process and would usually be completed in the time taken for the proprietor to answer. During the next phase the electronic diary is synchronised with the inventory data held centrally (135, 140) so that the on screen display shows current status to the proprietor while he is engaged with the customer enquiry (145). The supplier may use the PPC (Palmtop Personal Computer) keyboard or “mouse” to check or modify on-screen data and may cause the interchange of further details with the database (150,155,160). It will be appreciated that the terms keypad and mouse also include equivalents such as touchscreen and pointer technologies.

Once a customer booking is accepted (165) the proprietor enters the details in the electronic diary which retains a copy in it's appropriate diary page and transfers data defining the change to the central database (175). The database is updated 180 and once the customer call terminates (190,195), the diary terminal effects disconnection of the data communication (200).

Considering then FIG. 3, the customer terminal 6 (an instant-on type ppc as previously mentioned) has a link to (e.g.) an ISDN line such as that provided by British Telecommunications public limited company under the name “Home Highway” (trademark). Home Highway allows a single telephone line at a customers premises to provide a mix of analogue and ISDN communications. Using intelligent network termination equipment (NTE) it is possible to provide multiple connection capability allowing simultaneous use of any two of a plurality of analogue and digital terminations. Thus in the present invention, an incoming telephony call (PSTN or ISDN) to the home highway NTE is connected to a telephone 7. The ringing signal, while activating the alert device in the telephone 7, is also detected by the terminal 6 which responds by switching itself on (so that it displays a diary type window) and which uses the other available home highway channel to effect an ISDN connection to the destination database (FIG. 4).

While as hereinbefore mentioned the terminal 6 is preferable a PPC, screen phones which integrate telephony with a touch screen, keyboard and browser software may be used. One screen phone suitable for use in the invention is that provide by Samsung Corporation under the name Samsung Anyweb (trademark).

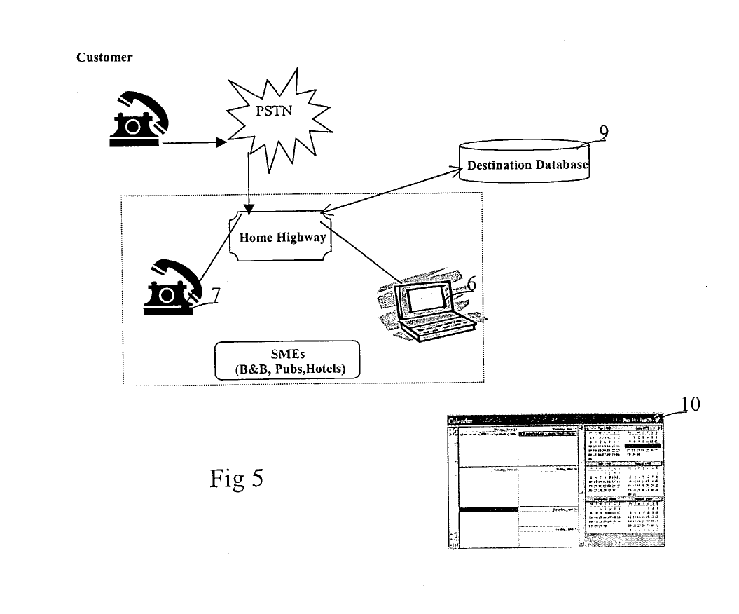

Once the ISDN connection has been established then (FIG. 5) the diary pages are synchronised and updated and are available for completion of display.

Incoming call detection on the terminal 6 may be by use of an incoming call detector function of a modem card (not shown). For both analogue incoming calls and ISDN incoming calls the serial port connector usually include a connection (Pin 9) configured to identify an incoming call to the terminal. Thus while the modem is not being used to answer incoming calls it's detection capability may be used to cause start up. Prior to effecting connection to the database, the terminal may be programmed to detect and examine the incoming calling line identity whereby calls for known friends and family sources do not result in an automated connection to the database. Where no automated connection is made it will still be possible for the proprietor to force a connection to the database and, in any event, to view the current diary page stored locally.

The intermediary may be programmed to use CLI of unknown callers to retrieve possible personal details (name/address for example) which may be transferred to the terminal 6 to facilitate input of booking information.

Within an intelligent network, it is possible to effect triggering of special network programming in respect of calls incoming to suppliers. Thus the network may establish the connection between the intermediary and the terminal 6. The network may also respond to incoming calls to suppliers so that even if a direct customer call is made, once non-business CLI's are screened out, a connection between the terminal 6 and the database may be effected.

Ina further development of the intermediary function, a person seeking accommodation may call the intermediary which by use of CLI or cell location could determine the callers current location. Using Geographic parameters held in the central database the intermediary may then identify any available accommodation in the caller's vicinity. The caller may be prompted to input additional information using the telephone keypad so specify accommodation type required, number of guests, length of stay etc so that the intermediary program routes the call to an appropriate destination based on known availability but without committing the supplier.

On connection of a call the intermediary may increment a connection count for the particular supplier so that the number of calls referred to the supplier is known. The connection count may be modified if a call results in a change in inventory data such that the number of successful booking calls may be assessed.

By agreement, where a number of suppliers are based in the same location, access to diary availability of other suppliers in the same area may be made available to each of them. Thus in a co-operative arrangement, if one supplier is unable to meet the needs of a particular customer he may be able to advise the calling customer of a potential alternative.

1. A reservation system comprising an electronic diary system at each customer premises of a plurality of customers, and a central data base accessible by way of a telecommunications network, the central data base including a respective copy of at least some fields of each customer diary, each said electronic diary system being responsive to an incoming voice call to a first connection at the customer premises to establish a call through a second connection at the same premises to the central database and to synchronise with said central database at least one data field relating to booking of facilities at said customer premises, the diary system further including display means to display said synchronised information and means responsive to customer data entry to re-synchronise said at least one data field with said central database.

2. A reservation system as claimed in claim 1 in which the central database includes an associated connection to one or more intermediaries whereby each such intermediary may check the potential availability of a required commodity before attempting direct communication with the customer premises.

3. A reservation system as claimed in claim 2 in which the commodity comprises accommodation facilities.

4. A reservation system as claimed in any preceding claim in which the network through which customer connection is made includes facilities to intercept calls, determine potential customer requirements and refer calls directly to suppliers shown as having availability.

5. A reservation system as claimed in claim 4 in which the network includes time of day and/or day of week interception capability so that unsocial hours calls to an enquiry line can be prevented.

6. A reservation system as claimed in claim 3 in which the data fields held in respect of each customer diary include data defining at least some accommodation related parameters (for example) minimum and maximum customer numbers for each of a plurality of rooms, number of rooms available and identity of such rooms together with date related data defining availability of each identified room.

7. A reservation system as claimed in any preceding claim including means responsive to a caller access to the system to effect automatic connection to an appropriate customer premises telephone line.

8. A reservation system as claimed in claim 7 in which a referral count is incremented each time automatic connection is effected whereby billing may be based on the number of referrals made.

9. A reservation system as claimed in claim 7 or claim 8 in which referrals resulting in a change of status of one or data fields may result in a successful referral count being incremented.
